(19) United States
(12) Patent Application Publication
(10) Pub. No.: US 2020/0226515 A1
(43) Pub. Date: Jul. 16, 2020

(54) MOVEMENT PLAN PROVISION SYSTEM, MOVEMENT PLAN PROVISION METHOD, AND PROGRAM

(71) Applicant: HONDA MOTOR CO., LTD., Minato-ku, Tokyo (JP)

(72) Inventors: Kenta Kawakami, Wako-shi (JP); Tomoya Miyazaki, Tokyo (JP); Yuki Tanaka, Wako-shi (JP)

(21) Appl. No.: 16/491,584

(22) PCT Filed: Mar. 17, 2017
(86) PCT No.: PCT/JP2017/010921

§ 371 Date: Sep. 6, 2019

(51) Int. Cl. G06Q 10/06; G06Q 10/02

(52) U.S. Cl. CPC G06Q 10/06311; G06Q 10/02

(57) ABSTRACT

A movement plan provision system includes an analyzer configured to analyze an attribute of a user on the basis of life information related to a life of the user, which is information collected by an electronic apparatus present in a life space of the user, a group generator configured to generate a group to which a user having a predetermined relationship belongs, on the basis of the attribute of the user analyzed by the analyzer, and a movement plan provider configured to provide a movement plan according to the relationship of the group generated by the group generator to a plurality of users belonging to the group generated by the group generator.

### TECHNICAL FIELD

The present invention relates to a movement plan provision system, and a movement plan provision method.

### BACKGROUND ART

In the related art, in a case in which a user wishes to a transferal of a movement means, the user transmits a transferal request to a server using a mobile phone or a personal computer, and information related to the movement means that is able to be used for transferal is transmitted from the server to the mobile phone or the personal computer (for example, refer to Patent Literature 1).

### CITATION LIST

### Patent Literature

### Patent Literature 1

Japanese Unexamined Patent Application, First Publication No. 2006-11813

### SUMMARY OF INVENTION

### Technical Problem

However, for a user who has difficulty in operating a terminal device or a busy user, a work of transmitting the transferal request to the server may be complicated in some cases.

The present invention has been made in consideration of such circumstances, and an object of the present invention is to provide a movement plan provision system, and a movement plan provision method capable of reducing effort of a user who receives a provision of a movement plan.

### Solution to Problem

(1): A movement plan provision system includes an analyzer configured to analyze an attribute of a user on the basis of life information related to a life of the user, which is information collected by an electronic apparatus present in a life space of the user, a group generator configured to generate a group to which a user having a predetermined relationship belongs, on the basis of the attribute of the user analyzed by the analyzer, and a movement plan provider configured to provide a movement plan according to the relationship of the group to a plurality of users belonging to the group generated by the group generator.

(2): The movement plan provision system of according to (1), the movement plan provider provides a movement plan for riding on the same movement means to a plurality of users belonging to the same group generated by the group generator.

(3): The movement plan provision system according to (1) or (2), an added value provider configured to provide an added value to a user determined to participate in the movement plan is further included.

(4): The movement plan provision system according to (3), the added value provider increases the added value as the number of participants in the movement plan increases.

(5): The movement plan provision system according to any one of (1) to (4), an evaluator configured to acquire an evaluation result obtained by evaluating the group generated by the group generator on the basis of information representing a situation of the user when participating in the movement plan is further included, and the group generator generates the group on the basis of the evaluation by the evaluator.

(6): The movement plan provision system according to any one of (1) to (4), an evaluator configured to acquire an evaluation result obtained by evaluating the movement plan provided by the movement plan provider on the basis of answer information from the user who has participated in the movement plan is further included, and the movement plan provider acquires the movement plan on the basis of the evaluation by the evaluator.

(7): A movement plan provision method causes a computer to analyze an attribute of a user on the basis of life information related to a life of the user, which is information collected by an electronic apparatus present in a life space of the user, generate a group to which a user having a predetermined relationship belongs, on the basis of the attribute of the user analyzed by the analysis, and provide a movement plan according to the relationship of the group to a plurality of users belonging to the generated group.

(8): A program causes a computer to analyze an attribute of a user on the basis of life information related to a life of the user, which is information collected by an electronic apparatus present in a life space of the user, generate a group to which a user having a predetermined relationship belongs, on the basis of the attribute of the user analyzed by the analysis, and provide a movement plan according to the relationship of the group to a plurality of users belonging to the generated group.

### Advantageous Effects of Invention

According to (1), (2), (7), and (8), it is possible to receive the provision of the movement plan that is suitable for the user without requiring the provision of the movement plan by the user.

According to (3) and (4), it is possible to promote participation of the movement plan.

According to (5) and (6), it is possible to generate an optimal group based on an actual situation, an impression of the user, or the like when the movement plan is executed, or it is possible to acquire the movement plan.

### BRIEF DESCRIPTION OF DRAWINGS

FIG. 1 is a schematic diagram of a movement plan provision system.

FIG. 2 is a diagram showing a functional constitution of a movement plan provision device.

FIG. 3 is a diagram showing an example of a content of life information.

FIG. 4 is a diagram showing an example of a content of user attribute information.

FIG. 5 is a diagram showing an example of a content of group information.

FIG. 6 is a diagram showing an example of a content of movement plan information.

FIG. 7 is a diagram showing an example of a content of user address information.

FIG. 8 is a diagram showing an example of a content of reservation information.

FIG. 9 is a diagram showing an example of a content of added value information.

FIG. 10 is a diagram showing an example of a content of use situation information.

FIG. 11 is a diagram showing an example of a content of evaluation information.

FIG. 12 is a diagram showing an example of a content of evaluation feedback information.

FIG. 13 is a flowchart showing a process executed in the movement plan provision device.

### DESCRIPTION OF EMBODIMENTS

Hereinafter, an embodiment of a movement plan provision system, and a movement plan provision method according to the present invention will be described with reference to the drawings.

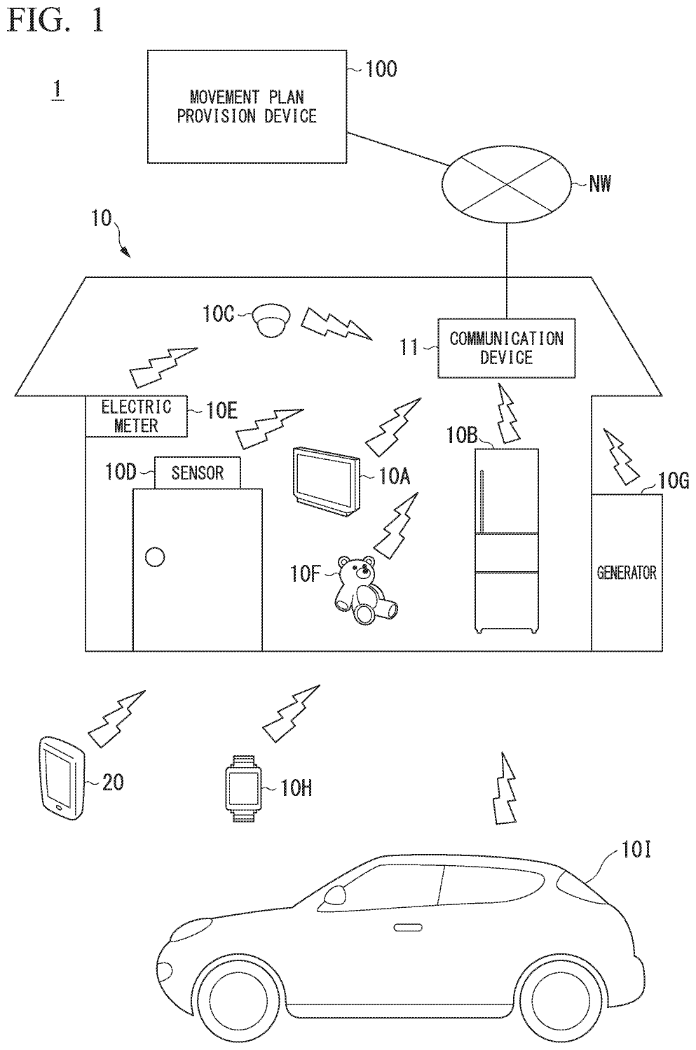

FIG. 1 is a schematic diagram of a movement plan provision system 1. As shown in FIG. 1, the movement plan provision system 1 includes a plurality of electronic apparatuses 10 (10A to 10I in the figure) communicating with each other through a network NW, a terminal device 20 of a user, and a movement plan provision device 100. The network NW includes, for example, some or all of a wide area network (WAN), a local area network (LAN), the Internet, a provider device, a wireless base station, a dedicated line, and the like.

Hereinafter, a constitution example in which a plurality of electronic apparatuses 10 are connected to the network NW through a communicator (gateway device) 11 will be described. However, the present invention is not limited thereto, and some or all of the plurality of electronic apparatuses 10 may directly communicate with the movement plan provision device 100 without passing through the communication device 11.

The plurality of electronic apparatuses 10 are various electronic apparatuses present in a life space of the user, and for example, the plurality of electronic apparatuses 10 may include a television 10A, a refrigerator 10B, a camera 10C, a sensor 10D, an electric meter 10E, an interactive robot 10F, a generator 10G, a wearable terminal 10H, an in-vehicle device 10I, and the like. The plurality of electronic apparatuses 10 have a communication function of communicating with the communication device 11.

The communication device 11 is, for example, a wireless LAN router installed in a house of the user, a wireless LAN router of the user which is portable, or the like.

The terminal device 20 is a terminal operated by the user, and is, for example, a desktop computer, a notebook computer, a personal digital assistant (PDA), a smartphone, or a tablet terminal.

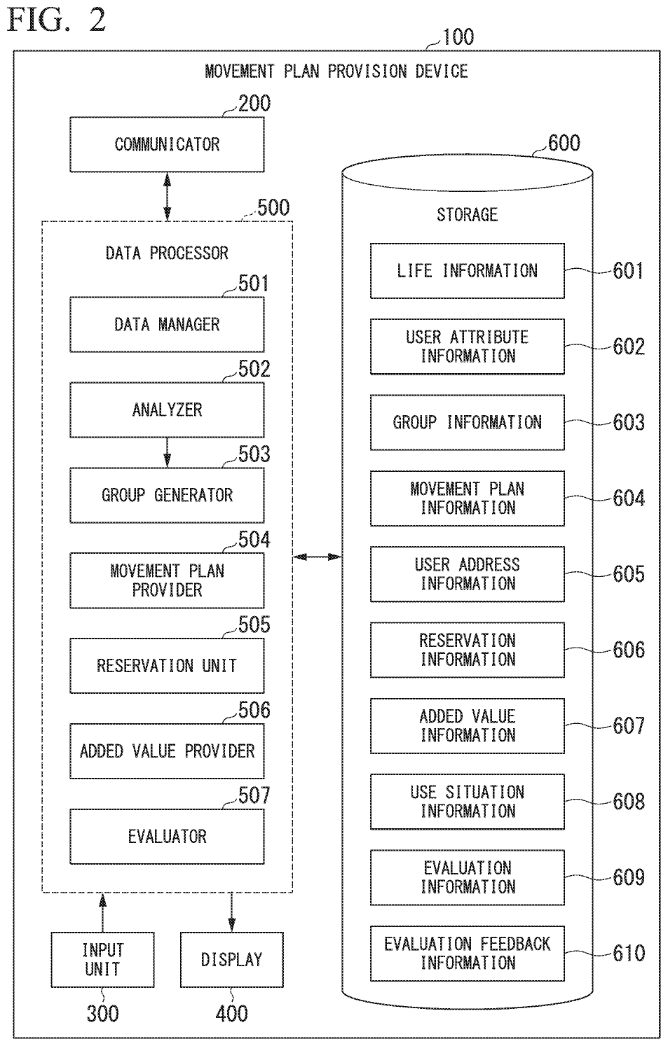

Next, a constitution of the movement plan provision device 100 will be described with reference to FIG. 2. FIG. 2 is a diagram showing a functional constitution of the movement plan provision device 100. As shown in FIG. 2, the movement plan provision device 100 includes a communicator 200, an input unit 300, a display 400, a data processor 500, and a storage 600.

The communicator 200 communicates with the plurality of electronic apparatuses 10 and the terminal devices 20 through, for example, the network NW. The communicator 200 acquires various pieces of information from the electronic apparatus 10 through the network NW, and outputs the various pieces of information to the data processor 500.

The input unit 300 includes, for example, some or all of various keys, buttons, a dial switch, a mouse, a touch panel formed integrally with the display 400, and the like.

The display 400 is, for example, a liquid crystal display (LCD), an organic electroluminescence (EL) display, or the like.

Each constitution element of the data processor 500 is realized, for example, by a processor such as a central processing unit (CPU) executing a program (software) stored in the storage 600. In addition, some or all of the constitution elements of the data processor 500 may be realized by hardware such as a large scale integration (LSI), an application specific integrated circuit (ASIC), or a field-programmable gate array (FPGA), and may be realized by cooperation of software and hardware.

The data processor 500 includes a data manager 501, an analyzer 502, a group generator 503, a movement plan provider 504, a reservation unit 505, an added value provider 506, and an evaluator 507.

The data manager 501 stores the various pieces of information acquired by the communicator 200 in the storage 600. In addition, the data manager 501 transmits the various pieces of information and the like read from the storage 600 to the electronic apparatus 10 and the terminal device 20 through the communicator 200 and the network NW.

The analyzer 502 analyzes an attribute of the user on the basis of life information. The life information is information collected by the electronic apparatus 10 present in a life space of the user, and is information related to a life of the user. The life information includes, for example, browsing history information of the television 10A, information indicating a content of the refrigerator 10B, information indicating a time zone or a destination where a vehicle on which the in-vehicle device 10I is mounted travels, age, gender, or the like of the user registered in the electronic apparatus 10 in advance. The user attribute includes a plurality of predetermined items, and includes, for example, a hobby, a life pattern, a friendship, an age, a sex, a living area, the content of the refrigerator, a timing to go shopping, a timing to use a car, a television to watch well, an item such as a food often bought.

The group generator 503 generates a group to which a user having a predetermined relationship belongs, on the basis of the attribute of the user analyzed by the analyzer 502. The predetermined relationship includes, for example, many similar points, many common points, similar tastes, close shopping timing, and the like. In addition, the group generator 503 may generate the group on the basis of evaluation by the evaluator 507.

The movement plan provider 504 provides a movement plan according to the relationship of the group to a plurality of users belonging to the same group generated by the group generator 503. The movement plan is a plan involving some kind of movement, and includes, for example, a plan for riding on the same movement means, a plan for moving on any movement means and joining on the way, a plan for transferring to the same movement means after joining, or the like. The movement plan provider 504 transmits, for example, information related to the movement plan to the electronic apparatus 10 or the terminal device 20 of a target user using the communicator 200.

In addition, the movement plan provider 504 may acquire the movement plan according to the relationship of the group from the movement plans prepared in advance, and may generate the movement plan according to past evaluation of a member belonging to the group, which is movement plan according to the relationship of the group, on the basis of the evaluation by the evaluator 507.

The reservation unit 505 provides the user with information related to an application using the communicator 200 in a case in which the user has applied for participation in the movement plan. The reservation unit 505 transmits, for example, the information related to the application to the electronic apparatus 10 or the terminal device 20 of the target user using the communicator 200. Note that the reservation unit 505 may execute all processes until a reservation of the movement plan is completed on the basis of the application from the user.

The added value provider 506 provides an added value to the user who has determined to participate in the movement plan. The added value is a value added to the movement plan, and includes, for example, a point, a discount coupon, or the like. In addition, the added value provider 506 may increase the added value as the number of the participants in the movement plan increases.

The evaluator 507 acquires an evaluation result (hereinafter referred to as situation evaluation) obtained by evaluating the group generated by the group generator 503 and the movement plan provided by the movement plan provider 504 on the basis of the information representing the situation of the user when participating in the movement plan. The information representing the situation of the user when participating in the movement plan includes, for example, image data, audio data, or the like acquired in the movement means on which the user got on. The situation evaluation is an evaluation result analyzed on the basis of the situation when participating in the movement plan, and includes, for example, a value indicating whether a group constitution or a movement plan was appropriate for the user attribute, a value indicating whether a combination of the users in the group was appropriate, or the like. Whether or not the group constitution, the movement plan, or the combination of the users in the group was appropriate is determined on the basis of whether the user enjoys, is excited, is depressed, or the like.

For example, the evaluator 507 may analyze the image data or the audio data, detect a predetermined evaluation scene (for example, a laughing scene, a scene in which a talk is lively turned, or the like), and accumulate a predetermined score according to the detected evaluation scene. The evaluator 507 may acquire an evaluation result for each evaluation item by comparing an accumulated total score with a predetermined threshold value for each evaluation item. In addition, the evaluator 507 may recognize a face of the participated user from the image data to acquire the situation evaluation for each user.

In addition, the evaluator 507 acquires an evaluation result (hereinafter referred to as user evaluation) obtained by the user evaluating the group generated by the group generator 503 and the movement plan provided by the movement plan provider 504 on the basis of response information from the user who participated in the movement plan. The answer information is acquired, for example, by the user answering a question prepared for each evaluation item, and may be input by the user using the terminal device 20 of the user and may be collected by distributing a questionnaire when participating in the movement plan.

The storage 600 is realized by, for example, a random access memory (RAM), a read only memory (ROM), a flash memory such as a solid state drive (SSD), a hard disk drive (HDD), or the like. The storage 600 stores information such as life information 601, user attribute information 602, group information 603, movement plan information 604, user address information 605, reservation information 606, added value information 607, use situation information 608, evaluation information 609, and evaluation feedback information 610.

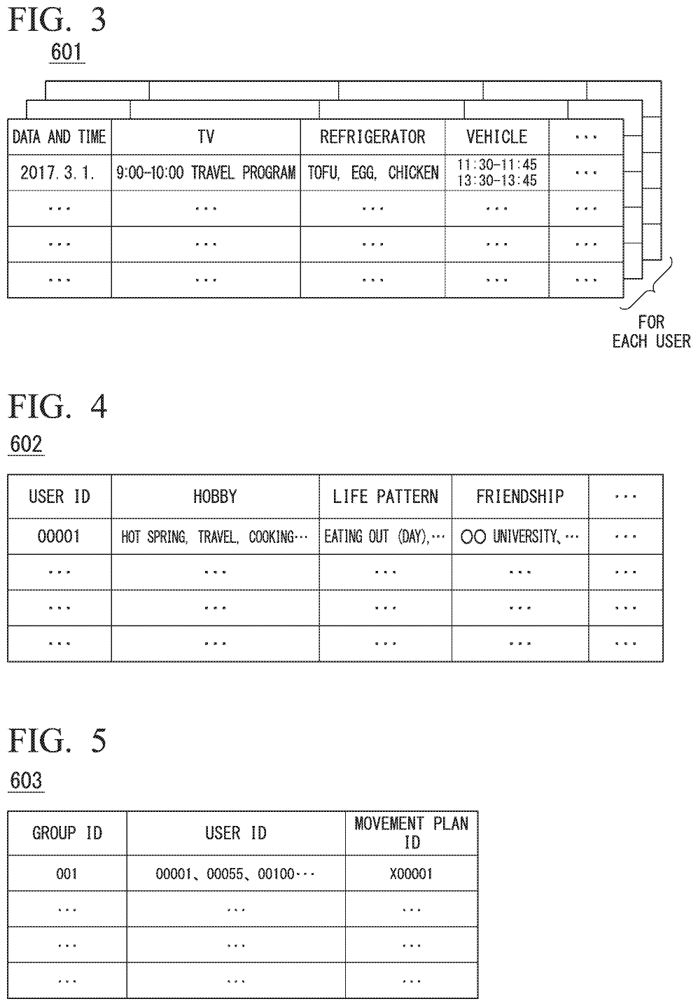

The life information 601 is information in which the life information received from the electronic apparatus 10 is associated. FIG. 3 is a diagram showing an example of a content of the life information 601. As shown in FIG. 3, for example, the life information 601 is stored in the storage 600 in a form of a table in which information indicating date and time and the life information are associated with each other. In an item of the life information, the life information detected by each electronic apparatus 10 is stored. Note that the table in which information indicating the date and time is associated with the life information is prepared for each user, and is associated with unique information (hereinafter referred to as a user ID) that identifies each user.

The user attribute information 602 is information indicating the user attribute analyzed by the analyzer 502, and is associated with each item of a predetermined user attribute. FIG. 4 is a diagram showing an example of a content of the user attribute information 602. As shown in FIG. 4, for example, the user attribute information 602 is stored in the storage 600 in a form of a table in which the user ID and information related to the user attribute are associated with each other. The information related to the user attribute includes, for example, information in which the user attribute is classified into items, such as a hobby, a life pattern, and a friendship. In each item of the user attribute, the user attribute analyzed by the analyzer 502 is stored.

The group information 603 is information related to the group generated by the group generator 503. FIG. 5 is a diagram showing an example of a content of the group information 603. As shown in FIG. 5, for example, the group information 603 is stored in the storage 600 in a form of a table in which a group ID, the user ID, and a movement plan ID are associated with one another. The group ID is unique information that identifies each group. In the user ID, a user ID indicating the user belonging to each group is stored. The movement plan ID is unique information that identifies each movement plan. In the movement plan ID, the movement plan ID indicating the movement plan provided to each group by the movement plan provider 504 is stored.

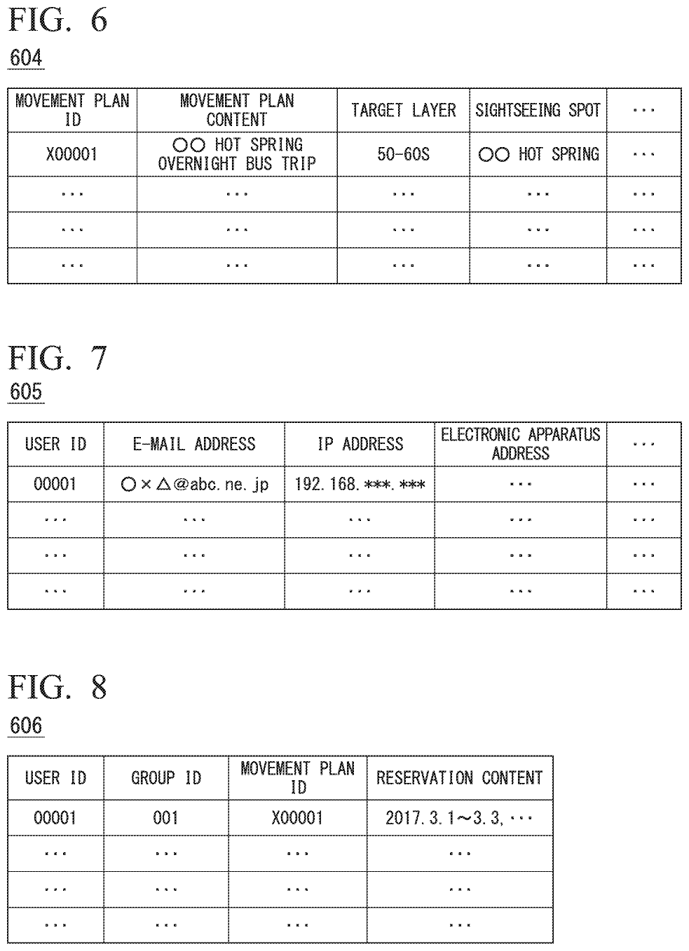

The movement plan information 604 is information related to the movement plan that is able to be provided to the user. FIG. 6 is a diagram showing an example of a content of the movement plan information 604. As shown in FIG. 6, for example, the movement plan information 604 is stored in the storage 600 in a form of a table in which the movement plan ID and the information related to the movement plan are associated with each other. The information related to the movement plan includes a movement plan content, a target layer, a sightseeing spot, and the like. The information related to the movement plan is, for example, information provided by a travel agent, a bus company, or the like.

The user address information 605 is identification information used when communicating with the plurality of electronic apparatuses 10 or the terminal device 20 of the user. FIG. 7 is a diagram showing an example of a content of the user address information 605. As shown in FIG. 7, for example, the user address information 605 is stored in the storage 600 in a form of a table in which an e-mail address, an IP address, and the like are associated with the user ID. In the e-mail address, for example, an e-mail address that is able to be browsed by the terminal device 20 of the user is stored. In the IP address, for example, an IP address allocated to the plurality of electronic apparatuses 10 or the terminal device 20 of the user is stored.

The reservation information 606 is information related to a reservation of the user. FIG. 8 is a diagram showing an example of a content of the reservation information 606. As shown in FIG. 8, for example, the reservation information 606 is stored in the storage 600 in a form of a table in which the user ID, the group ID, the movement plan ID, and a reservation content are associated with one another. In the user ID, a user ID indicating the user who has reserved the movement plan is stored. In the group ID, a group ID indicating the group to which the user indicated by the user ID belongs is stored. In the movement plan ID, a movement plan ID indicating the reserved movement plan is stored. In the reservation content, a content of the reserved movement plan (such as the date and time, a charge, or the like) is stored.

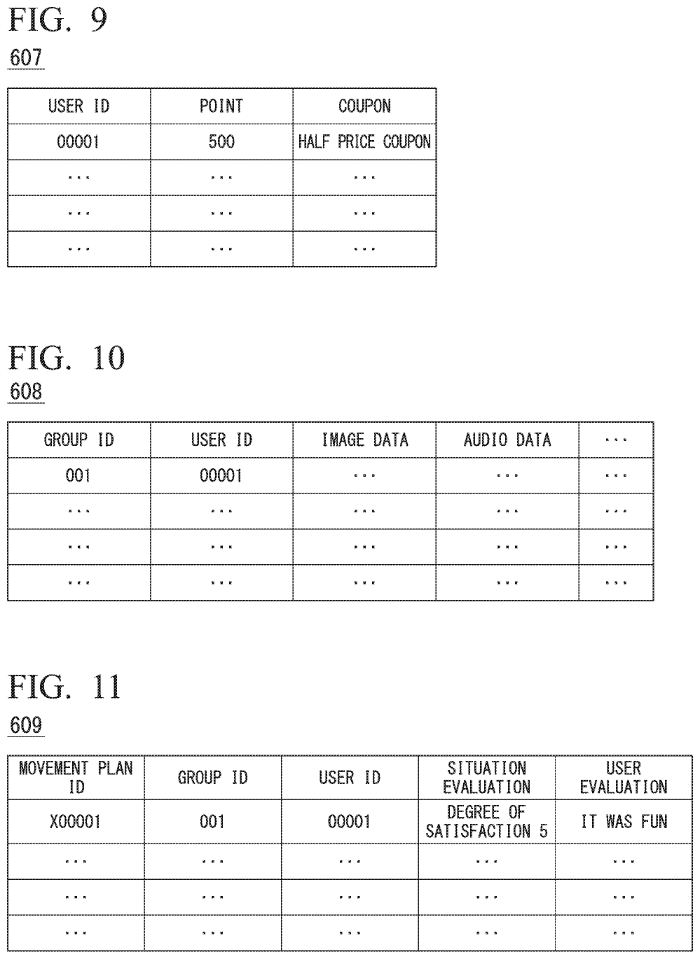

The added value information 607 is information related to the added value given to the user. FIG. 9 is a diagram showing an example of a content of the added value information 607. As shown in FIG. 9, for example, the added value information 607 is stored in the storage 600 in a form of a table in which the user ID and the added values are associated with each other.

The use situation information 608 is information indicating the situation of the user when participating in the movement plan. FIG. 10 is a diagram showing an example of a content of the use situation information 608. As shown in FIG. 10, for example, the use situation information 608 is stored in the storage 600 in a form of a table in which the movement plan ID, the group ID, the user ID, the image data, and the audio data are associated with one another. The image data and the audio data are an image obtained by photographing the inside of the movement means used by the user in the movement plan, a recorded audio, and the like.

The evaluation information 609 is information indicating the evaluation result when participating in the movement plan. FIG. 11 is a diagram showing an example of a content of the evaluation information 609. As shown in FIG. 11, for example, the evaluation information 609 is stored in the storage 600 in a form of a table in which the movement plan ID, the group ID, the user ID, the situation evaluation, and the user evaluation are associated with one another. The situation evaluation is the situation evaluation acquired by the evaluator 507 on the basis of the image data, the audio data, or the like acquired in the movement means. The user evaluation is the evaluation result based on the answer information acquired from the user.

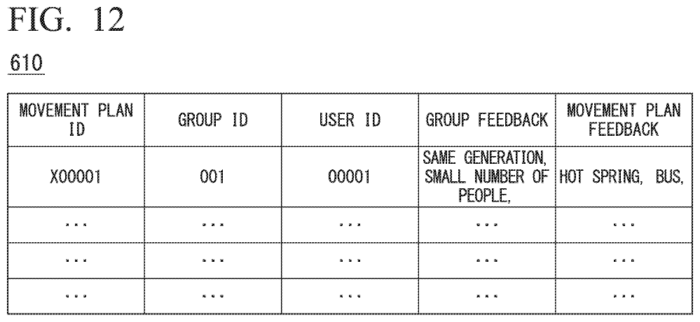

The evaluation feedback information 610 is information related to a process in which the evaluation information 609 is fed back to the generation of the group or the acquisition of the movement plan. FIG. 12 is a diagram showing an example of a content of the evaluation feedback information 610. As shown in FIG. 12, for example, the evaluation feedback information 610 is stored in the storage 600 in a form of a table in which the movement plan ID, the group ID, the user ID, a group feedback, and a movement plan feedback are associated with one another. The group feedback is information related to a process in which the group is generated on the basis of the evaluation result by the group generator 503, and includes, for example, a characteristic of the group reflected in the group generation. The movement plan feedback is information related to a process in which the movement plan is acquired on the basis of the evaluation result by the movement plan provider 504, and includes, for example, a characteristic of the movement plan reflected in the acquisition of the movement plan.

Next, an example of the feedback process of the evaluation results by the group generator 503 or the movement plan provider 504 will be described.

For example, the group generator 503 feeds back the evaluation result to the generation of the group for at least one of a user who obtained the situation evaluation or a user who performed the user evaluation (hereinafter, referred to as a specific user) on the basis of the situation evaluation or the user evaluation acquired by the evaluator 507.

For example, in a case in which the specific user is included in grouping users, the group generator 503 generates a group according to the specific user. The group generator 503 refers to the evaluation information 609, analyzes the characteristic of the group of preference of the specific user on the basis of the evaluation result of the past of the specific user, and generates a group according to an analysis result. The group generator 503 writes the characteristic of the group obtained by the analysis, a place where the evaluation result is reflected in the generation of the group, and the like in an item of group feedback of the evaluation feedback information 610.

In addition, the movement plan provider 504 feeds back the evaluation result to the acquisition of the movement plan for each specific user on the basis of the situation evaluation or the user evaluation acquired by the evaluator 507. For example, in a case in which the specific user is included in the users who acquire the movement plan, the movement plan provider 504 acquires the movement plan according to the specific user. The movement plan provider 504 refers to the evaluation information 609, analyzes the characteristic of the movement plan of preference of the specific user on the basis of the evaluation result of the past of the specific user, and generates a movement plan according to an analysis result or acquires the movement plan according to the analysis result from the movement plan information 604. The movement plan provider 504 writes the characteristic of the movement plan obtained by the analysis, a place where the evaluation result is reflected in the acquisition of the movement plan, and the like in the item of group feedback of the evaluation feedback information 610.

In addition, in the group generation or the acquisition of the movement plan, in a case in which the evaluation result is fed back, the movement plan provider 504 is able to provide the user with information related to the feedback (hereinafter, referred to as feedback information) together with the movement plan. In the feedback information, the reflection of the evaluation result of the specific user in the group generation or the acquisition of the movement plan, the place where the evaluation result is reflected (for example, information indicating a portion of the whole movement plan, which is generated on the basis of the evaluation of the specific user), and the like are included. The movement plan provider 504 generates the feedback information on the basis of the evaluation feedback information 610.

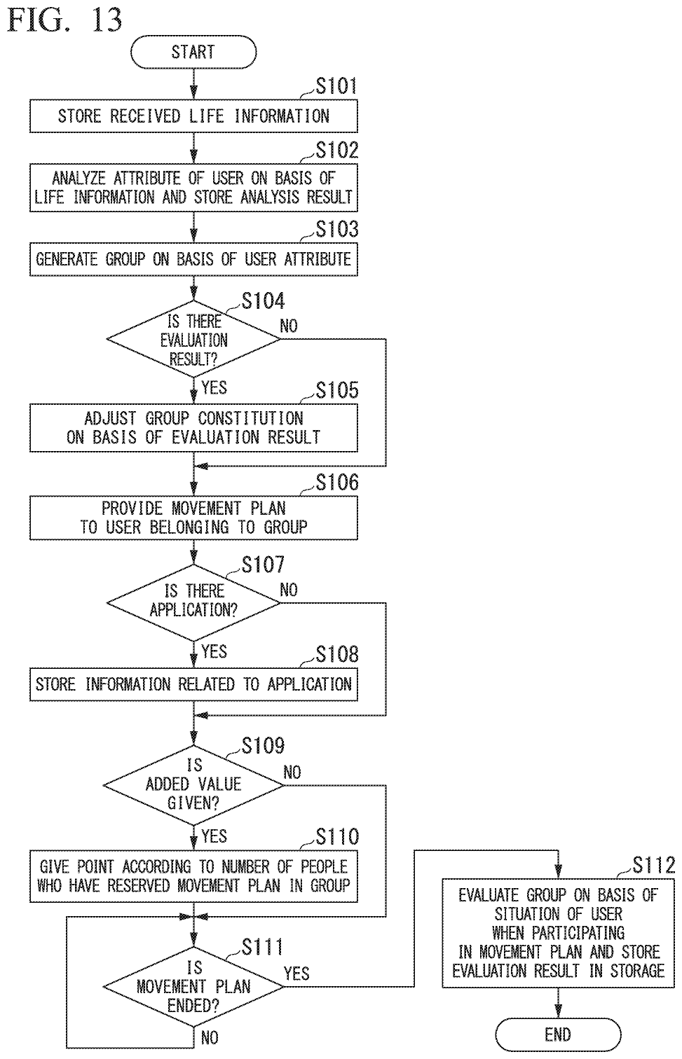

Next, a process executed in the movement plan provision device 100 will be described with reference to FIG. 13. FIG. 13 is a flowchart showing the process executed in the movement plan provision device 100.

First, the data manager 501 stores the life information received from the electronic apparatus 10 in the life information 601 (step S101). The data manager 501 periodically acquires the life information from the electronic apparatus 10 registered in advance, for example, at predetermined intervals. Next, the analyzer 502 analyzes the user attribute on the basis of the life information 601, and stores the analysis result in the user attribute information 602 (step S102). For example, the analyzer 502 writes the analysis result in the corresponding item among the items of the user attribute defined in the user attribute information 602. For example, in a case in which a browsing time of a hot spring travel or a travel program is equal to or greater than a threshold value in the browsing history by the television 10A, the analyzer 502 writes a keyword such as a hot spring or a travel in the item of the hobby. Note that, in a case in which the analysis result is different from a previous analysis result, the analyzer 502 may update the user attribute information 602 on the basis of the latest analysis result.

The group generator 503 generates the group to which the user having a predetermined relationship belongs, with reference to the user attribute information 602 (step S103). For example, the group generator 503 derives a degree of similarity for each item of the user attribute, and classifies the users of which a value obtained by adding the degrees of similarity of all items is greater than a predetermined threshold value into the same group. The present invention is not limited thereto, and the group generator 503 may classify the users on the basis of the degree of similarity of predetermined items, in accordance with the relationship between groups. For example, in a case in which a tour travel group is created, users who are close in age and have many similarities in hobbies are classified into the same group. In addition, in a case in which a group of transferal members for shopping is created, the group generator 503 may classify users who have the same area in which they live and have a small amount of remaining refrigerator into the same group. In addition, the group generator 503 allocates a new group ID to the generated group, associates the user ID of the user belonging to the group to the group ID, and stores the group ID and the user ID in the group information 603.

Next, the group generator 503 determines whether or not there is an associated evaluation result for the generated group (step S104). For example, the group generator 503 refers to the group information 603 and the evaluation information 609, determines whether or not users who were classified into the same group in the past are present in the same group this time, and in a case in which it is determined that the users who were classified into the same group in the past are present in the same group this time, the group generator 503 determines whether or not the evaluation of the past group in which the corresponding user is present is bad (for example, whether or not the evaluation is equal to or less than a threshold value). In a case in which the evaluation of the past group is bad, the group generator 503 adjusts a group constitution so that the users of which the evaluation is bad are different groups (step S105). The group generator 503 stores the user ID after the adjustment in the group information 603.

Next, the movement plan provider 504 refers to the user attribute information 602, the group information 603, and the movement plan information 604, acquires movement plan according to the relationship of the group from the movement plan information 604, and transmits the acquired movement plan to the electronic apparatus 10 or the terminal device 20 of the user who belongs to the group with reference to the user address information 605 (step S106). In addition, the movement plan provider 504 writes the movement plan ID indicating the movement plan provided to the user in the group information 603 in association with the user ID of the corresponding user.

Next, the reservation unit 505 determines whether or not there is the application of the movement plan from the user who provided the movement plan (step S107), and in a case in which there is the application, the reservation unit 505 provides the information related to the application to the user. In addition, in a case in which the application has been completed, the reservation unit 505 stores the information related to the reservation in the reservation information 606 (step S108).

Next, the added value provider 506 determines whether or not a reservation content of the user is a provision target of the added value on the basis of the reservation information 606 (step S109). In a case in which it is determined that the reservation content is the provision target of the added value, the added value provider 506 gives the added value according to the reservation content to the user, and stores the given added value in the added value information 607 (step S110). For example, the added value provider 506 gives a point, a discount coupon of a discount amount, or the like according to the number of people who have reserved the movement plan in the same group.

In addition, the evaluator 507 determines whether or not the movement plan is ended (step S111). For example, in a case in which an end time of the movement plan has passed, the evaluator 507 determines that the movement plan is ended, evaluates the group on the basis of the situation of the user when participating in the movement plan, and stores the evaluation result in the evaluation information 609 (step S112).

According to the embodiment described above, the analyzer 502 that analyzes the attribute of the user on the basis of the life information, the group generator 503 that generates the group to which the user having a predetermined relationship belongs, on the basis of the attribute of the user, and the movement plan provider 504 that provides the movement plan according to the relationship of the group to the plurality of users belonging to the group are provided. Therefore, it is possible to receive the provision of the movement plan that is suitable for the user without requiring the provision of the movement plan by the user.

For example, the movement plan provision device 100 is able to provide a tour of a hot spring trip in which users of the same age participate, to a user who is frequently watching a hot spring or a travel program on a television. In addition, the movement plan provision device 100 is also able to provide a transferal tour to a shopping mall for a user who lives in the same area and has mainly finished shopping at a nearby supermarket.

Therefore, even an elderly person who is not able to use a terminal device is able to receive the provision of the movement plan according to his or her life, and is able to apply for the movement plan of interest from among the provided provision. In addition, since the work of registering the desired conditions is troublesome for receiving the provision of the movement plan, it is possible to develop potential demand because it is possible to provide the movement plan even for potential users who did not use the movement plan.

In addition, according to the embodiment described above, the evaluator 507 that evaluates the group is further provided, and the group generator 503 generates the group on the basis of the evaluation by the evaluator 507. Therefore, it is possible to generate an optimal group based on an actual situation when the movement plan is executed. Thus, it is possible to generate a group suitable for the user each time the number of times of participation in the movement plan increases.

As described above, although the form for carrying out the present invention was described using an embodiment, the present invention is not limited at all by such an embodiment, and various modification and substitution can be added within the range which does not deviate from the gist of the present invention.

For example, the life information may include, information such as an age, a sex, and an address managed by a server of a maker, as purchaser information of the electronic apparatus 10.

In addition, the movement plan provider 504 may generate a part or all of the movement plan with reference to a database of an available movement means, accommodation facility, or the like.

What is claim is:

1.-8. (canceled)

9. A movement plan provision system comprising:
an analyzer configured to analyze an attribute of a user on the basis of life information related to a life of the user, which is information collected by an electronic apparatus present in a life space of the user;
a group generator configured to generate a group to which a user having a predetermined relationship belongs, on the basis of the attribute of the user analyzed by the analyzer; and
a movement plan provider configured to provide a movement plan according to the relationship of the group to a plurality of users belonging to the group generated by the group generator,
wherein the movement plan provider provides a movement plan for riding on the same movement means to the plurality of users belonging to the same group generated by the group generator.

10. The movement plan provision system according to claim 9,
wherein the electronic device is a television, and
the analyzer analyzes the attribute of the user on the basis of browsing history information of the television.

11. The movement plan provision system according to claim 9,
wherein the electronic device is a refrigerator, and
the analyzer analyzes the attribute of the user on the basis of a remaining amount in the refrigerator.

12. The movement plan provision system according to claim 9, further comprising:
an added value provider configured to provide an added value to the user determined to participate in the movement plan.

13. The movement plan provision system according to claim 12,
wherein the added value provider increases the added value as the number of participants in the movement plan increases.

14. The movement plan provision system according to claim 9, further comprising:
an evaluator configured to acquire an evaluation result obtained by evaluating the group generated by the group generator on the basis of information representing a situation of the user when participating in the movement plan,
wherein the group generator generates the group on the basis of the evaluation by the evaluator.

15. The movement plan provision system according to claim 9, further comprising:
an evaluator configured to acquire an evaluation result obtained by evaluating the movement plan provided by the movement plan provider on the basis of answer information from the user who has participated in the movement plan,
wherein the movement plan provider acquires the movement plan on the basis of the evaluation by the evaluator.

16. A movement plan provision method of causing a computer to:
analyze an attribute of a user on the basis of life information related to a life of the user, which is information collected by an electronic apparatus present in a life space of the user;
generate a group to which a user having a predetermined relationship belongs, on the basis of the attribute of the user analyzed by the analysis;
provide a movement plan according to the relationship of the group to a plurality of users belonging to the generated group; and
provide a movement plan for riding on the same movement means to the plurality of users belonging to the same group, when providing the movement plan.

17. A movement plan provision system comprising:
an analyzer configured to analyze an attribute of a user on the basis of life information related to a life of the user, which is information collected by an electronic apparatus provided in a home of the user;
a group generator configured to generate a group to which a user having a predetermined relationship belongs, on the basis of the attribute of the user analyzed by the analyzer; and
a movement plan provider configured to provide a movement plan according to the relationship of the group to a plurality of users belonging to the group generated by the group generator.

18. The movement plan provision system according to claim 17,
wherein the electronic device is a television, and
the analyzer analyzes the attribute of the user on the basis of browsing history information of the television.

19. The movement plan provision system according to claim 17,
wherein the electronic device is a refrigerator, and
the analyzer analyzes the attribute of the user on the basis of a remaining amount in the refrigerator.

20. The movement plan provision system according to claim 17, further comprising:
an added value provider configured to provide an added value to the user determined to participate in the movement plan.

21. The movement plan provision system according to claim 20,
wherein the added value provider increases the added value as the number of participants in the movement plan increases.

22. The movement plan provision system according to claim 17, further comprising:
an evaluator configured to acquire an evaluation result obtained by evaluating the group generated by the group generator on the basis of information representing a situation of the user when participating in the movement plan,
wherein the group generator generates the group on the basis of the evaluation by the evaluator.

23. The movement plan provision system according to claim 17, further comprising:
an evaluator configured to acquire an evaluation result obtained by evaluating the movement plan provided by the movement plan provider on the basis of answer information from the user who has participated in the movement plan,
wherein the movement plan provider acquires the movement plan on the basis of the evaluation by the evaluator.
